(19) United States
(12) Patent Application Publication
(10) Pub. No.: US 2014/0346846 A1
(43) Pub. Date: Nov. 27, 2014

(54) METHOD FOR MANUFACTURING A TWO-PART HYBRID WHEEL MADE OF A LIGHT ALLOY, IN PARTICULAR ALUMINUM

(71) Applicant: Emile Thomas Di Serio, Chenas (FR)

(72) Inventor: Emile Thomas Di Serio, Chenas (FR)

(73) Assignee: Saint Jean Industries, Saint Jean D'Ardieres (FR)

(21) Appl. No.: 14/352,518

(22) PCT Filed: Jul. 10, 2012
(86) PCT No.: PCT/FR2012/051625

§ 371 Date: Jun. 19, 2014

(30) Foreign Application Priority Data
Oct. 25, 2011 (FR) 1159645

(51) Int. Cl. B60B 3/04

(52) U.S. Cl. CPC B60B 3/041; B60B 2310/202; B60B 2310/208; B60B 2310/3025
USPC 301/63.103; 228/114

(57) ABSTRACT

The process of production of a hybrid wheel in light alloy of the type including a disk and a rim able to be rendered integral by a friction weld, is characterized by the fact that it involves the following working phases:

production of the front disk, obtained via a dual operation of casting of an initial foundry preform and transferring the said initial foundry preform into a forging die, plus the operation of forging of the aforesaid initial foundry preform in view of obtaining the front disk, and then the operation of flash removal to obtain the said front disk;

manufacturing of the rim portion, with production of a billet of light alloy, and conversion of the said billet into a circular flank obtained by hot or cold extrusion, followed by expansion of this circular flank to the dimensions of the final rim, plus the operation of hot or cold flow-forming of the circular flank to the final form and profile of the rim;

assembly of the front disk portion and the rim via welding, involving a friction welding operation after machining of the areas to be assembled. The invention covers the production of hybrid and light alloy wheels manufactured in accordance with the process.

### BACKGROUND

1. Technical Field

The invention concerns the technical domain of wheels, particularly for vehicles and automotive vehicles, and also the technical domain of casting and forging for the production of parts made of light alloy, particularly aluminum, particularly intended for the automobile industry.

2. Description of the Related Art

The production of wheels with a one-piece flange and rim obtained by molding is known, for example, but necessitates complex and costly technical facilities and requires large thicknesses that give rise to an excessive weight of the wheel in relation to current requirements.

According to prior art, in accordance with FIG. 1 concerning the two above-cited aspects, it is already known how to produce hybrid wheels (R) in two parts, including a rim portion (1) and a front disk portion (2) or wheel disk, with these two parts being rendered integral by any appropriate means of joining.

To remedy this, it has been proposed—for example, in patent EP 0 854 792 to produce a hybrid wheel in two parts in accordance with a particular process. The joining of the rim and the flange is done by means of a joint welded via an operation of cyclical movement friction welding. This technology, which has been used by one of the Applicant's subsidiaries, caters satisfactorily to the market's requirements. However, the use of this process gives rise to some disadvantages in relation to the new requirements of the market, which are—for example—to obtain a reduction in weight of the products of around 20 to 30%. Moreover, in the said patent EP 0 854 792, the welded rim of the wheel is based on a tube cast by centrifuging, and converted by rolling or by friction in order to obtain the desired configuration of the final wheel. The two parts of the wheel are composed of a welded aluminum alloy. These operations are long and costly. In addition, it is necessary to perform X-ray inspections on the flange.

Moreover, since 1983, the Applicant has been using a technology combining a casting phase and a phase of forging of parts made of aluminum alloy, under the brand name “COBAPRESS”. This technology is described in patent EP 119 365, and consists in producing an initial foundry preform by casting a light alloy such as aluminum or aluminum alloy, and then transferring the initial foundry preform to a forging die with dimensions considerably smaller than the dimensions of the initial cast part, in order to then perform a forging operation allowing one to obtain the desired properties of the final part. A flash removal operation is then performed on the periphery of the final part obtained after forging.

One of the problems of manufacturing hybrid wheels in two parts—particularly the disk portion—consists in the presence of different radial stems that connect the peripheral edge of this disk portion with the central part of it forming the hub, which will then be directly connected to secure the wheel onto the wheel drive shaft. FIG. 2 shows a partial view of the disk (2). The production via casting of this type of part involves special constraints regarding the areas of supply breaks (2a) that occur in the joining nodes (2b) between the peripheral edge of the disk and the opposing ends of the stems. One can clearly see supply breaks that occur in the said nodes.

These supply breaks can only be remedied in traditional casting by the use of alloys that are more-easily-castable alloys of known type—for example, under the reference AS11. Nonetheless, these alloys do not confer the same mechanical characteristics, and are not always adequate for entirely eliminating this kind of defect. Another solution consists in increasing the cross-section of the stems of the wheel, which naturally increases the weight of the wheel.

### BRIEF SUMMARY

Therefore, the Applicant's approach has been to work from the above-stated technologies to design another system of manufacturing a hybrid wheel in two parts, made of a light alloy such as aluminum, that remedies the problem and caters to the market requirements.

### BRIEF DESCRIPTION OF SEVERAL VIEWS OF THE DRAWINGS

The Figures contain drawings of prior art and the implementation of the invention.

FIG. 1 is a schematic view of a hybrid wheel in two parts (disk and rim), illustrated separately and illustrated assembled.

FIG. 2 is a partial view of the disk portion according to prior art, with an illustration of the areas of supply breaks on the arms.

FIG. 3 is a schematic illustrating the obtaining of the disk by extrusion, followed by its final shaping through cold flow-forming.

FIG. 4 is a schematic illustrating the process of production of the rim portion according to the three phases of formation of the circular flank via extrusion (P1), followed by expansion (P2) of the said circular flank, and then of flow-forming (P3).

### DETAILED DESCRIPTION

The solution devised by the Applicant is the fruit of extensive work and experimentation conducted in-house, because the various lines of research and work undertaken have revealed a number of constraints incompatible with the needs and the conditions of usage for these hybrid wheels.

Therefore, the Applicant has had to design and develop a new process from a special selection of working procedures.

Thus, and according to a first characteristic of the invention, the process of production of a hybrid wheel in light alloy of the type including a front disk and a rim able to be rendered integral by a friction weld is remarkable in that it involves the following working phases:
production of the front disk, obtained via a dual operation of casting of an initial foundry preform and transferring the said initial foundry preform into a forging die, plus the operation of forging of the aforesaid initial foundry preform in view of obtaining the front disk, and then an operation of flash removal to obtain the said front disk;
manufacturing of the rim portion, with production of a billet of light alloy, and conversion of the said billet into a circular flank obtained by hot or cold extrusion, followed by expansion of this circular flank to the dimensions of the final rim, plus an operation of hot or cold flow-forming of the circular flank to the final form and profile of the rim;
assembly of the front disk portion and the rim via welding, involving a friction welding operation after machining of the areas to be assembled.

The process in accordance with the invention seems to be particularly high-performing, and has the following advantages:
the wheel overall has a fatigue resistance that is twice what is generally achieved, particularly during bend fatigue tests;
the wheel has a better performance during impact tests (energy absorbed is greater, without cracking of the periphery of the wheel disk);
the cross-section of the rim is finer because of its manufacturing through extrusion, thereby reducing weight. The obtaining of such a thickness is impossible via gravity or low-pressure casting;
the problem of impermeability with the rim is eliminated, because of its production process including the hot or cold flow-forming operation.

The problem of obtaining nodes in the stems of the disk portion is resolved, because the process of manufacturing of this part resolves the internal defects such that there are practically no such defects. In addition, with this particular process of production of the disk portion, it is possible to achieve an optimal design of the configuration of this part, by varying the side of the front face that is not visible. One can, for example, increase the sections of the casting and eliminate the surplus material in the burring at the time of forging. In addition, another major advantage lies in the use of the semi-finished product constituted by the disk obtained by extrusion. This is because the disk of a given diameter allows the production of different profiles of rim, independently of the disk obtained via the successive operations of casting and forging according to the COBAPRESS process. Defects are reduced in the foundry preform and weight is not added to the final part.

By using the disk production process known as the “COBAPRESS process”, a large variety of profiles can be used, without limits; casting problems are eliminated, being resolved by the process itself.

Through this particular implementation, web sections in the stems of the disk can be obtained, that can be as little as 4 mm, the geometries of which are impossible to accomplish with traditional casting. Thus, total optimization is achieved, with a controlled weight reduced to the greatest-possible extent. Moreover, the surface condition is improved in the disk portion in relation to a disk produced via traditional casting. A perfect surface condition is obtained by the forging operation, and it is no longer necessary to have a mold dressing for the casting, with a fine grain; this can be an immense problem because the mold dressing deteriorates, unlike with a strike casting. One prevents porosities close to the surface from bursting and their bubbling during the heat treatment (a phenomenon commonly called “bubbling”), which are a cause of rejection giving rise to the loss of the added value instilled in the wheel (up to 15% of visual rejections).

Other advantages are provided by the implementation of the process according to the invention, particularly with regard to tooling.

Therefore, the invention aims at a selective combination of the various phases of the process for the obtaining and production of each of the two components, namely the rim and the disk.

The utilization of friction welding of the two components also contributes to the obtaining of the final part, a hybrid wheel that is particularly uniform and reliable in terms of quality.

As regards the optimization of the weight of the hybrid wheels obtained, the measurements taken during tests returned the following results:

| | 19″ wheel | 18″ wheel | 17″ wheel |
|---|---|---|---|
| Initial weight | 13.5 kg. | 12.5 kg. | 10.2 kg. |
| Weight through the process | 10 kg. | 10.5 kg. | 9.0 kg. |
| according to the invention | | | |
| Saving | 3.5 kg. | 2.0 kg. | 1.2 kg. |

This weight saving has considerable consequences regarding the production of carbon dioxide. Through the lightening of just the four wheels of the vehicle, the weight saving reduces the consumption of gasoline or diesel.

We have identified, as an example, a profile of the rim but, as stated previously, the process according to the invention is particularly advantageous because, using one single diameter of disk, one can obtain different profiles in the rim portion.

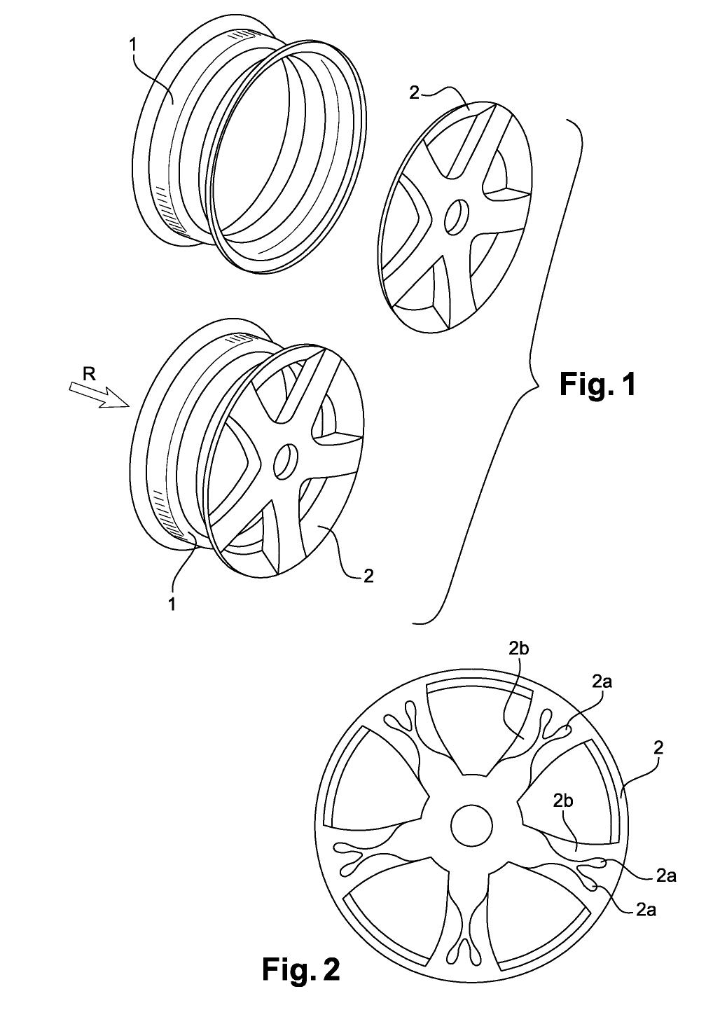

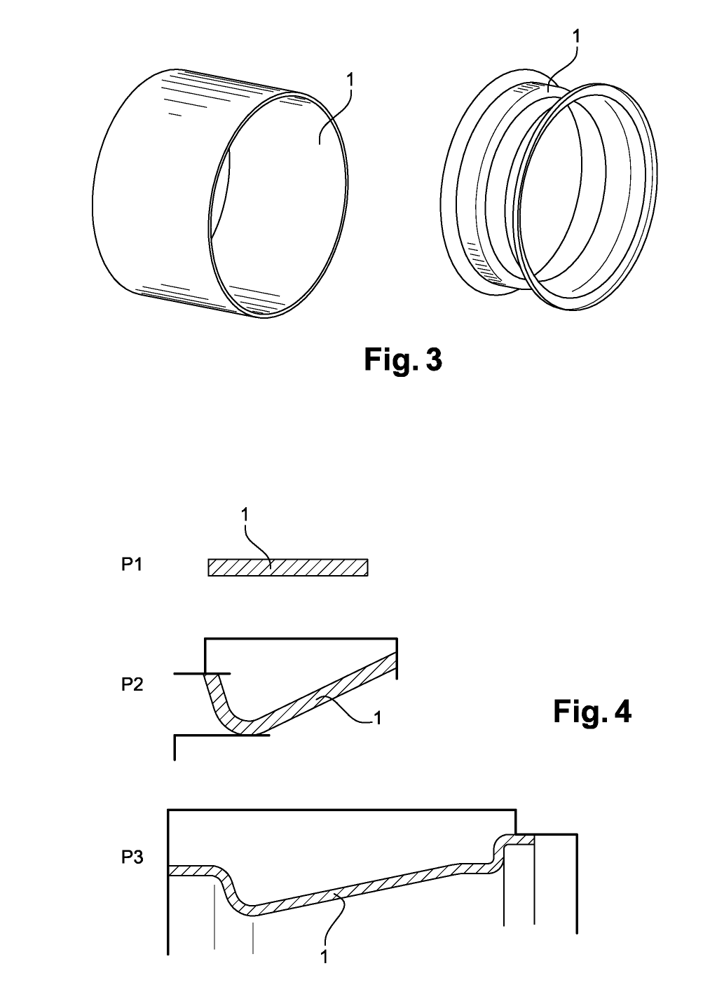

The final product obtained according to the invention is not illustrated because, overall, it has the same shapes as the hybrid wheel illustrated in FIG. 1.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. Process of production of a hybrid wheel in light alloy of the type including a front disk and a rim able to be rendered integral by a friction weld, comprising:
production of the front disk, obtained via a dual operation of casting of an initial foundry preform and transferring the said initial foundry preform into a forging die, plus the operation of forging of the aforesaid initial foundry preform in view of obtaining the front disk, and then the operation of flash removal to obtain the said front disk;
manufacturing of the rim portion, with production of a billet of light alloy, and conversion of the said billet into a circular flank obtained by hot or cold extrusion, followed by expansion of this circular flank to the dimensions of the final rim, plus the operation of hot or cold flow-forming of the disk to the final form and profile of the rim; and
assembly of the front disk portion and the rim via friction welding.

2. A hybrid wheel in light alloy, including a disk and a rim comprising a disk portion produced through a dual operation of casting of an initial foundry preform, followed by forging, the rim portion produced through a triple operation of extrusion, followed by expansion, then flow-forming, with the rim portion and the disk portion then being assembled by a friction welding operation.
